(19) United States
(12) Patent Application Publication
(10) Pub. No.: US 2015/0100354 A1
(43) Pub. Date: Apr. 9, 2015

(54) TICKET INVENTORY CONTROL

(71) Applicant: Live Nation Entertainment, Inc., Beverly Hills, CA (US)

(72) Inventors: Michael Horowitz, Manhattan Beach, CA (US); Bradford J. Bensen, Gilbert, AZ (US)

(73) Assignee: Live Nation Entertainment, Inc., Beverly Hills, CA (US)

(21) Appl. No.: 14/046,700

(22) Filed: Oct. 4, 2013

(51) Int. Cl. G06Q 10/02

(52) U.S. Cl. CPC G06Q 10/02
USPC 705/5

(57) ABSTRACT

Systems and methods dynamically group seats in a venue to provide for discretized ticket pricing. Data and information (e.g., historical sales data, venue data, etc.) are used to compute a grouping metric for seats in a venue that is reflective of a desirability of the seat. An inventory manager sets a parameter, which influences how the seats are grouped into sections. For example, the manager can slide a marker across a sliding bar to identify a number of unique sections. Metric ranges are set accordingly, and seats are appropriately assigned to sections based on which range their metrics fall within. An interactive seat map presents an indication as to which seats are assigned to which sections (e.g., via coloring, the indication further indicating a number of unique groups) while an inventory manager adjusts the parameter.

### BACKGROUND

This disclosure relates in general to methods and systems for assigning resources via a network, and in particular, to methods and systems for managing inventory of tickets and resources of a venue.

Event ticketing typically involves pricing and selling tickets. Certain conventional techniques statically price event tickets. That is, once a price is set for a ticket or class of tickets with respect to an initial sale of those tickets, the price does not change. Further, using conventional techniques, ticket pricing is often based on insufficient information, resulting in ticket prices that do not accurately reflect the actual demand for such tickets. Conventional ticket inventory management tools fail to provide adequate interfaces for enabling users to quickly manage ticket inventory.

### BRIEF SUMMARY OF THE INVENTION

In some embodiments, systems and methods dynamically group seats in a venue to provide for discretized ticket pricing. Data and information from one or more sources can be used to compute a grouping metric for each seat, which can reflect a desirability of a ticket for the seat. Data and information may include historical sales data (e.g., past prices and dates of ticket original purchases or resales), venue data (e.g., seat locations), demographics data, and the like. An inventory manager can set a parameter (e.g., by sliding a marker across a sliding bar), which can influence how the seats are grouped. For example, the parameter can set a number of unique sections or an average or minimum number of seats to assign per section. Based on the parameter, ranges of metrics can be defined. Each seat can then be assigned to a section based on which range its metric is within. Seats in a section may be assigned a similar or same price. Certain embodiments provide a interactive seat map to present an indication (e.g., in real-time) as to which seats are assigned to which sections (e.g., via coloring, the indication further indicating a number of unique groups) while the inventory manager adjusts the parameter.

One embodiment of the present invention provides a method of grouping seats in a venue by accessing a set of seat records, each seat record of the set of seat records may correspond to a seat in the venue and include data associated with the seat in the venue. The data may include an identification of a location within the venue. For each seat record in the set of seat records a seat grouping metric may be determined based on the data of the seat record. A seat grouping parameter from an inventory manager may be received, and a range of values of the seat grouping metric may be determined based on the seat grouping parameter. A subset of the set of seat records, wherein each seat record in the subset being associated with a seat grouping metric within the determined range of values may be identified and a corresponding seat in a section may be assigned for each seat record in the subset. A seat map for the venue may be presented to the inventory manager with an identification of the seats assigned to the section. When a change to a seat grouping parameter is received a new range of values of the seat grouping metric may be determined and a second subset of the set of seat record may be identified. For each seat record in the second subset a section may be assigned. The same price may be assigned to each seat record in the set of seat records.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a block diagram of an embodiment of a ticket-management interaction system.

FIG. 2 depicts a block diagram of an embodiment of ticket inventory management system.

FIG. 3 depicts an example of a seat grouping metric divided into sections.

FIG. 4A depicts a seat map of a venue with a control for adjusting a section size.

FIG. 4B depicts a seat map of a venue with a control for changing seat grouping in the venue.

FIG. 5 illustrates a flowchart of an embodiment of a process for grouping seats into sections.

FIG. 6A illustrates a flowchart of an embodiment of a process for changing grouping of seats.

FIG. 6B illustrates a flowchart of an alternative embodiment of a process for changing grouping of seats.

FIG. 7 illustrates a flowchart of an embodiment of an iterative process for satisfying seat grouping parameters.

FIG. 8 illustrates a flowchart of an embodiment of a process for grouping seats and generating a release schedule.

FIG. 9 depicts a block diagram of an embodiment of a computer system.

FIG. 10 depicts a block diagram of an embodiment of a special-purpose computer system.

### DETAILED DESCRIPTION OF THE INVENTION

The ensuing description provides preferred exemplary embodiment(s) only and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes can be made in the function and arrangement of elements without departing from the spirit and scope as set forth in the appended claims.

Conventional approaches to ticket inventory management suffer from significant deficiencies. Conventional techniques often set ticket prices for certain tickets at a disadvantageous price in terms of maximizing profits. In some cases, a price for the ticket may be set too low, as ticket purchasers would have been willing to pay more than the set price for the ticket. In other instances, the ticket price may be set too high, thereby dissuading potential ticket purchasers from purchasing the ticket. As a result, tickets may go unpurchased. Either under-pricing and over-pricing of the ticket therefore results in a loss of potential revenues to the ticket seller, the performer/artist, and the promoter.

Often, conventional approaches to ticket inventory management tools group tickets for seats in a venue into sections. Seats grouped into sections are often assigned a similar or the same price. Sections are often designated based on their physical locations within a venue. All seats within a specific location within a venue may be grouped together into a section.

Grouping seats into sections or price levels may provide many benefits to ticket purchasers. Ticket purchasers may find it easier to find seats in their price range, purchase multiple tickets at the same or similar price by selecting a section. It also provides a convenience to ticket providers, who can easily identify limited purchase prices and assign large blocks of seats to select prices.

However, grouping tickets into sections for pricing based only on the location of the seats may also create situations of under-pricing or over-pricing and cause ticket purchaser frustration. In some venues, the grouping of seats into sections based on their physical locations may cause some seats in the section to be under-priced while some seats to be dramatically over-priced. For example, grouping the seats in the first 20 rows of a venue into one section and assigning the same price level to each seat in the section may result in ineffective pricing. Seats on the far ends of the rows, for example, may have poor stage visibility compared to the seats in the middle of the rows. Likewise first-row seats may be much more in demand than row-20 seats. Differences in the location within a section may result in a different customer experience depending on which seat in the section the ticket purchaser is assigned to. Avoiding over-pricing, under-pricing, and ticker purchaser frustration is difficult in this type of section grouping. That is, it is difficult to balance trying to set a price low enough to sell all tickets in the section but to also recover the true value of the best seats. Regardless of the price level for the section, ticket purchasers who were assigned tickets to the seats at the ends of the rows of the section may be frustrated that they paid the same or similar amount as the purchasers assigned tickets to the seats in the middle of the row of the section. Alternatively, these end-of-the-row seats may be of higher value due to their ease of access to venue amenities, such that the people in the middle of the row feel like they did not receive the same value for the price.

In embodiments described herein, ticket inventory management tools and methods are described to allow the benefits of assigning section price levels but to nevertheless reduce the problems with block prices (e.g., under-pricing, over-pricing, and ticket purchaser frustration).

As will be described in greater detail below, in certain embodiments, individual seats in a venue are assigned a seat grouping metric. The seat grouping metric may be a score, numerical value, rating, and the like that reflects a measure of the seat's desirability (e.g., its value or rating with respect to a desirability characteristic, such as nearness to an event, facing the sun, clear view of the event, etc.) The metric may be determined for each seat based on a variety of data and information about the venue, seat characteristics, historical data, price data, demographics, performer data, and the like. In some embodiments, a set of metrics (each pertaining to a different desirability measure or being computed using different data) is assigned to each seat.

Seats of a venue may be grouped into sections based on the value of the assigned metrics. In some embodiments, a range of values of metric values may be specified as corresponding to a seat section. For example, if the values for metric for all the seats in a venue range from 1 to 100, seats with a metric in the range of 1 to 10 may be grouped to one section, seats with a grouping metric in the range of 11 to 20 may be grouped to another section, and so on. In other embodiments, specific values of the metric may be specified as corresponding to a seat section. For example, seats assigned metric values of 1, 5, 8, or 20 may be grouped into one section while seats assigned seat grouping metric values of 2, 6, 30, or 80 may be grouped into another section.

The metric may be based on data that reflect a value of a seat. The grouping may be used to reduce under-pricing and over-pricing limitations based on traditional grouping of seats into sections. The grouping of seats into sections based on a metric allows for a more diverse and dynamic grouping.

For example, the metric for seats in a venue may be at least in part based on the viewing angle from each seat to the stage. Seats that have a direct view of the stage in a venue may be assigned a low metric value corresponding to the viewing angle. Seats that have an angled view of the stage in a venue may be assigned a higher metric value corresponding to the viewing angle. In this example, seats with a low value of the metric (direct view of the stage) may be grouped to a first section and seats with a high value of the seat grouping metric (side angle view of the stage) may be grouped into a second section. The first section may be assigned a higher price level than the second section.

The metric may be based on many different characteristics of seats in a venue, the historical sales data, and the like. Data used to generate the metric may be changed for each event, venue, season, artist/performer, event type, and the like. The data used to generate the metric may be changed during the sale of tickets for an event. In some embodiments, the data ranges of the seat grouping metric that are used to group the seats into specific sections may also be changed at any time, for different events, venues, and the like to capture sections the price levels that reflect the seat value of the seats. For example, for one specific event, such a theater performance, the angle of view of the stage may be an important characteristic that reflects the value of the seat. For another type of event, such as a symphony, the sound quality at each seat may be the most important characteristic. Using a different seat grouping metric based on different data for each event, seats may be grouped into sections and assigned a price level that captured the value of the seats for each event.

Further, the tools and methods may allow an inventory manager or event provider to dynamically change the grouping based on new data or sale performance. The number of sections or price levels may be dynamically adjusted during the onsale period for an event. Adjustments may be made to increase revenues, increase sales, meet a sellout date, and the like.

Resale data from third party sales and real-time sales may be used to dynamically adjust or change the grouping. Resale prices of tickets may be used to expand or reduce the size of a section. After a grouping of seats into sections has been performed and the price for a section has been set the resale, values of tickets may be monitored. The resale price for seats around a section or around the perimeter of a section may be monitored to determine if the seats should be added or grouped into the section or removed from a section. If one or more seats from a different section, originally prices at a lower price, are being sold at a similar price than a neighboring higher priced section it may be an indication that that more seats from the neighboring section may be regrouped into the higher priced section. The resale value or auction sides, third party ticket resale sites may be monitored to determine the grouping of seats into sections and the price level set for each section. In embodiments the real time resale data may be used to change the characteristics of a group including the price of the group, when the tickets are offered for sale, and/or the like. Resale data may be used to determine the metric used to determine grouping in real-time based on recent sales data, user activity, sales trends, and the like.

Inventory release schedule may also be used to adjust or change the grouping of seats. When determining a the value of a seat or the grouping for seats, the amount of inventory released and/or the release schedule may be used by the system. In embodiments tickets for seats may be released in batches or blocks according to a release schedule. The release schedule may be timed or designed to increase the demand for the tickets, increase revenue, and/or increase sales rate compared to an all at once release of tickets. In embodiments the metric may include information about the release schedule and/or the availability of the seat. The metric may reflect the current availability of current seats or similar seats, and when/which additional seats may be made available later.

The ticket inventory management system may include a predictive engine to provide automated means for generating the seat grouping metric. A predictive engine may use historical data, learning algorithms, decision algorithms, neural networks, and the like to suggest to the event provider or inventory manager types of data to use for the computation of the seat grouping metric. In some embodiments, the predictive engine may automatically calculate a metric using data evaluated to be appropriate for the type of event, venue, time, demographics, and the like. The predictive engine may use one of more of historical ticket sales data, data from ticket sales in similar venues, events, sale predictive methods and the like to select data for the computation of the seat grouping metric. The predictive engine may use any number of data sets related to ticket sales and seat characteristics of similar venues and events. As described in U.S. application Ser. No. 11/702,803 filed on Feb. 6, 2007, which is hereby incorporated by reference in its entirety for all purposes, there are many different factors that may affect the ticket value and which may be used to predict the potential value of a ticket.

The ticket inventory management system may provide for means to automatically or semi-automatically set the ranges and/or values or the seat grouping metric that are used to groups seats into sections. The ranges or value of the seat grouping metric used for the grouping the seats into sections may be calculated or determined by the tool based on an indication of one or more parameters provided by the inventory manager or the event provider. The parameters may be indicative of a number of sections, an upper and/or lower threshold on a sizes of the sections (e.g., thereby constraining a total number of seats that can have tickets sold as a particular price level), an upper and/or lower constraint in terms of seat continuity (e.g., prohibiting section assignments that would result in a single seat having a price different than either of its side neighbors), and/or an upper and/or lower threshold on dollar amounts between price levels. Notably, a single parameter indicative of one of the above features may be indirectly fully or partly indicative of one or more other such features. Thus, e.g., a single “section granularity” marker may pertain to a multiple of the above features.

An inventory manager may be allowed to influence ticket prices in several ways. First, an inventory manager may identify desirability characteristics to use when calculating metrics. Such identification can be explicit (e.g., by selecting “sun location”) or implicit (e.g., by selecting an event type, event date and/or performer which can influence desirability characteristics). In one instance, the inventory manager can weight a plurality of desirability characteristics, such that metrics are influenced in a corresponding manner. Second, the inventory manager can adjust one or more parameters to influence section definitions. For example, the inventory manager may slide a marker along a continuous or discrete slider, enter a numeric number, or select between options. The manager may be further able to specify the parameter (e.g., as being indicative of a number of sections or inter-section price differentials) and/or to set constraints on sections assignments (e.g., to prohibit seat assignments that would result in less than 5 contiguous seats at a particular price level). The metrics can then be used to, in real-time and based on the parameter(s), assign seat sections. The seat sections can be presented to the inventory manager, such that he can change his parameter setting if desired. In one instance, a seating map is color coated, with each color representing a different section. Thus, as the manager moves the parameter in one direction, fewer unique colors on the map can represent fewer distinct sections. Third, the inventory manager may set prices for various sections.

It will be appreciated, however, that selection of one or more desirability characteristics to use in metric calculations and/or setting of one or more parameters can be performed automatically. The selection and/or setting can be based on empirical data and/or a model in an attempt to arrive at section assignments and pricing that would, e.g., optimize or increase expected or predicted revenue or profit, time of sellout, or other sale ticket sale metric.

In some embodiments the ticket inventory management system may be configured to generate more than one grouping of seats into sections for an event. Multiple configurations or grouping of seats in a venue into section may be generated. Different grouping of seats may be presented or made available to different distribution channels or users. In one embodiment, a grouping of seats into section for an event may be generated for each known user. The preferences of a user, their purchase history, and other information that may be received from the user or the user's account may be used to generate a grouping of seats and a price structure specifically tailored to the user. In some embodiments, a user may be known to have specific preference for a seat or seat type. Based on a user's profile, a user may be known to prefer seats only with a specific quality of feature. The grouping of seats into section presented to the user may be generated based on mainly or in substantially large part based on that preference (e.g., to assign metric scores or groupings based on user preferences). Different users may have vastly different preferences and hence many different groupings of seats may be generated. For example, one specific user may have strong preference for choosing seats based on seats the best sound quality. The seats in the venue may be grouped into sections based largely on the sound quality. The seats with the best sound quality may be grouped into one section and assigned one price level, seats with a lower sound quality rating may be assigned to another section and assigned lower price level.

A user who is most interested in sound quality may find it easier to find a seat at a quality and price level matching the preferences and budget of the user when the seats are grouped and presented to the user based on the user's preferences. In another example, a second user may prefer seats in areas that do not experience a lot of spectator traffic from people leaving and entering their seats. The second user may be presented with a seat map with seats grouped and priced into section based mostly or completely on the spectator traffic near the seats. Seats with lowest spectator traffic may be grouped into one section and priced highest, for example. In embodiments the value that users place on specific seats may be quite different for different users based on their preferences. Grouping seats based on the user's preferences may extract the most value out of each seat.

In embodiments, the system may be configured to ensure a level of price uniformity for the seat sections and seat prices presented to different users or different distribution channels. Bounds for the minimum price and/or maximum price may be specified or generated for each seat that must be met regardless of the grouping or grouping preferences for a user. In embodiments the price presented to a user, regardless of the metrics used for grouping of seats into sections may be configured not differ my more than +/−10% or +/−25% or more from a baseline seat price.

In addition to generating grouping of seats based on specific user preferences of histories, different grouping metrics may be generated for different distribution channels based on the channels demographics, purchase histories, and the like. For example, a distribution channel such as an internet or web store, for some events, attract a younger demographic than a physical ticket broker. Based on the demographics data the seats for the web store may be grouped into sections based on different metrics than for the physical ticket broker.

In embodiments, user preferences may be used to calculate or change seat characteristics such as when a ticket for a seat is made available to the user, how it influences a metric, and/or how it influences the price of a ticket. The profile characteristics of user may be periodically analyzed to determine demographic trends and/or profile changes. Changes in demographics, for example, may influence seat values. For example, an increasing percentage in younger users may change the seat value and metrics. Younger event goers may place a higher preference for seats closer to a stage, for example. The trends of an increased number of younger users may be used to adjust the seat metric and assign high values to seats closer to the stage, for example.

Embodiments of the ticket inventory management system and methods which provide for the ability to group seats into sections based on a seat grouping metric the present invention will now be described using the figures.

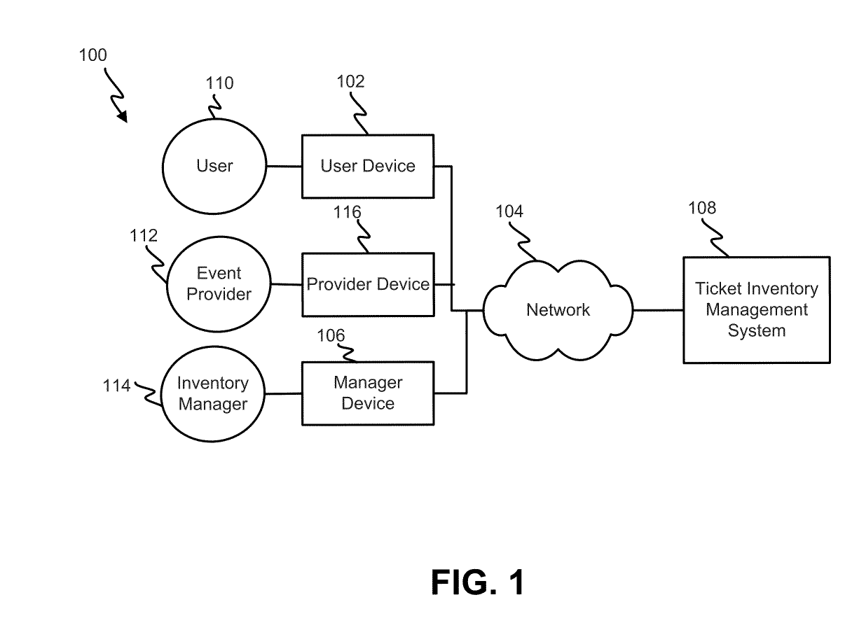

Referring first to FIG. 1, a block diagram of an embodiment of a ticket-management interaction system 100 is shown. The ticket management system 100 may include a ticket inventory management system 108. Users 110, event providers 112 (e.g., a sports team manager or a vendor operator), and/or inventory managers 114 can interact with a ticket inventory management system 108 via respective devices 102, 106, and 116 and a network 104, such as the Internet or a wide area network (WAN), local area network (LAN) or other backbone. In some embodiments the event provider and the inventory manager may be the same. In some embodiments, the ticket inventory management system 108 is made available to one or more of users 110, event providers 112, and/or inventory managers 114 via an app (that can be downloaded to and executed on a portable electronic device) or a website. It will be understood that, although only one user 110, event provider 112, and inventory manager 114 are shown, the system 100 can include multiple users 110, event providers 112, and/or inventory managers 114.

Using the ticket management system 100, an event provider 112 can identify an event (e.g., its name and/or performer(s)), event type, a date or dates of the event, a location or locations of the event, etc. Examples of events for which tickets can be obtained include sporting events, concerts, meals, shows, movies, and amusement parks. As described further below, the ticket management system 100 can use the information provided by event provider 112 and/or inventory manager 114 to allocate tickets for the event, group tickets into sections and identify a price level for each section. For each event, the ticket management system 100 can generate and store one or more sections and assign price levels to each section. The grouping of seats into section may be at least partially based on data related to, historical sales data, event demographics, time of sale, secondary market ticket prices, and/or physical characteristics of the location of the seats.

An inventory manager 114 and/or event provider 112 can then use the ticket inventory management system 108 to modify the price levels of each group of the tickets for the event or the venue. Ticket inventory management system 108 may present to the inventory manger 114 and/or event provider 112 a set of tools and/or a graphical user interface for managing the inventory. The tools and user interface may present the inventory manger 114 and/or event provider 112 with a venue map with an indication of sections and price levels computed based on the metrics, with an indication of computed metrics (e.g., presented over the venue map) and/or with an indication of a desirability characteristics, grouping parameters, data used to compute the seat grouping metric (e.g., presented over the venue map) and/or the like. The tools and interface may allow the determination of metrics, seating zones and/or prices for the seats of a venue. An example of an interface may be found in U.S. application Ser. No. 13/289,337 filed on Nov. 4, 2011, which is hereby incorporated by reference in its entirety for all purposes. The system interface may be used to set or modify the grouping of seats into sections. The system interface may be used to select or change the data used to determine the metric and/or one or more parameters used for grouping seats into sections. The ticket system interface may be used by an inventory manager 114 and/or event provider 112 to set one or more parameters influencing metric-based grouping into sections or for the system to automatically or semi automatically determine the appropriate data to use for calculation of the seat grouping metric and any parameters.

In embodiments, the user interface may include and/or be configured to alert the user to inventory changes, metric changes, and/or changes in tickets sales trends that may. The interface may generate alerts or notification prompting the inventory manager 114 and/or event provider 112 to review the seat inventory and seat grouping when certain thresholds have been met. For example, the inventory manager may be alerted to a drop in inventory below a specific threshold and may prompt the manager to reassess the grouping and/or value assigned to each seat or seat section.

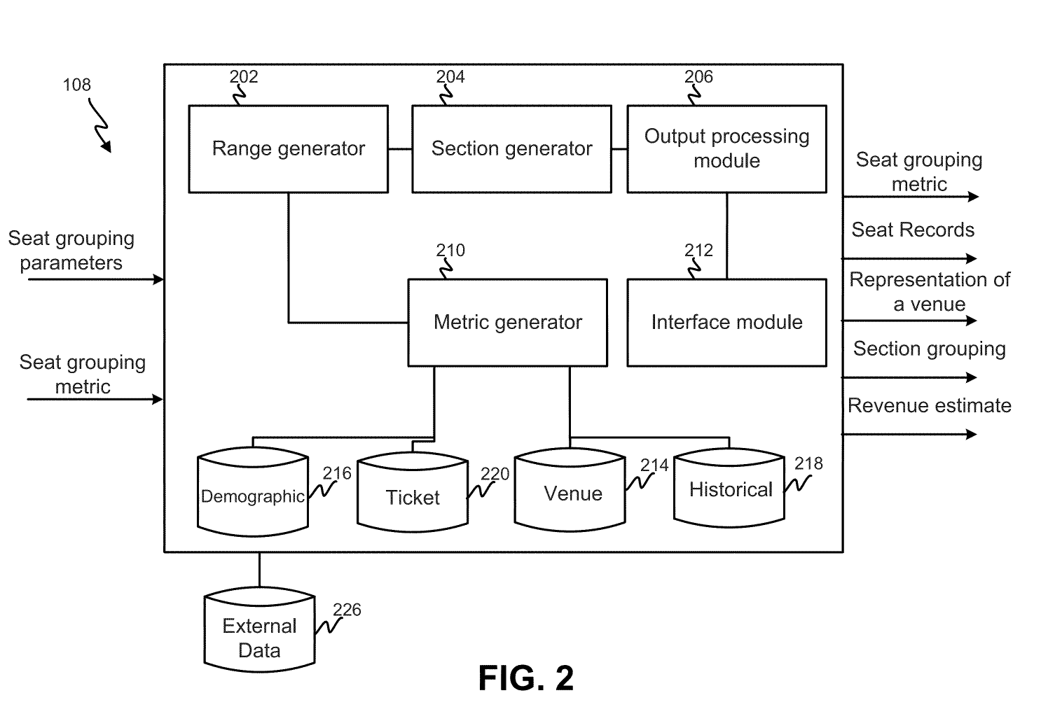

Referring next to FIG. 2, a block diagram of an embodiment of the ticket inventory management system 108 is shown. The ticket inventory management system 108 can be, in part or in its entirety, in a cloud. In some instances, at least part of the ticket inventory management system 108 is present on a device, such as a user device 102, a provider device 116, or a manager device 106. For example, a metric generator 210 (described further below) or section generator 204 can be on a manager device 106, and a range generator 202 can be in a cloud. In some instances, part of a component (e.g., part of a range generator 202) resides in a cloud and another part of the component resides in a device. Thus, the ticket inventory management system 108 can include a distributed system.

The ticket inventory management system 108 may include one or more data sources. The data sources may be databases, text files, data streams, spreadsheets, and the like. It will be appreciated that disclosures herein that refer to a database may alternatively refer to a different data source type. Data sources may be local to the to the ticket inventory or may be external. The data sources may, for example include a venue database 214, historical database 218, demographic database for potential or past ticket purchasers 215, and/or other ticket database 220. The ticket inventory management system 108 may interface to one or more external data sources or databases 226 related to venue data, ticket sales data, weather data, geographic data, and the like. The internal and/or external data sources may be used by the metric generator 210 to compute or determine the metric for seats in a venue. The metric generator 210 may parse and analyze internal and external data sources. The metric generator 210 may interface with the databases 216, 220, 214, 218, and 226 to access data.

The metric generator 210 may use the data accessed from the data sources to compute the seat grouping metric. The seat grouping metric calculated or determined for each seat may be based on data of one or more types (e.g., past sales data and sun-positioning data) related to each seat. In some embodiments, the seat grouping metric may be determined directly from the data. In some embodiments, the seat grouping metric may be calculated. Calculations may include comparison operations, lookup operations, arithmetic operations, and the like. Calculations may result in a value, or a set of values for the seat grouping metric for each ticket or seat. The metric generator 210 may access data from the data sources and determine what calculations need to be performed. The seat grouping metric for each seat may be output of the system 108. In some embodiments, the seat grouping metric may be received by the system 108 from an external source. The seat grouping metric may have been computed by another ticket inventory management system for example.

After the seat grouping metric is computed or received by the system 108, the seats may be grouped into sections using at least in part the seat grouping metric. For some events or venues, the system 108 may receive an indication of one or more seat grouping parameters. The seat grouping parameters may influence and/or constrain grouping seats into sections. For example, the parameter can specify or influence a number of groups or an average group size. The grouping parameter(s) may influence the minimum number of seats in a section and/or the maximum number of seats in a section. Additionally or alternatively, the grouping parameter(s) may specify, influence and/or restrict a distributions of seats in the sections, e.g., by specifying an upper and/or lower bound on a number of contiguous seats within a particular section or all sections (e.g., indicating that each seat must be within a seat block of at least 4 seats, all of which are within a same section). In embodiments, the seats in the venue may be grouped into hundreds or even thousands of sections. Sections may have as few as one or two seats in some embodiments. Each section may be assigned a different price. The venue may therefore have hundreds or thousands of different price level. In some embodiments each seat may have a different price. In some other embodiments, the seats in the venue may be grouped into a few large sections. The venue may have ten, two, or even just one section with only a few price levels.

The seat grouping parameters may, for one or more events or venues, be derived from data such as the historical data, using the section generator 204. Historical data may include historical ticket sales, ticket sale trends, attendance information, past section seat groupings, ticket prices, and/or the like. Once the seat grouping parameters are received or derived, the range generator 202 of the system 108 may be used to determine the ranges and/or values of the seat grouping metric that may be used to group the seats into different sections. The range generator 202 may determine the ranges and initiate the section generator 204 to group the seats into sections. In some embodiments, the section generator 204 may group the seats according to the ranges determined by the range generator 202. The seats may be grouped into one or more “premium” and/or “discount” section with different price levels. The seats may be grouped into multiple sections identified with section number. In some embodiments, seat grouping parameters may influence the number of ranges and/or the span of the ranges.

During grouping or after grouping, the section generator 204 may verify that the grouping satisfies the restriction specified by the seat grouping parameters. If the restriction is not satisfied, the section generator 204 may be configured to change some of the ranges or change values of the seat grouping metric used to define each section. For example, if a restriction requiring all seats in section to be contiguous is not satisfied, the section generator 204 may relax change the ranges of the metric defining one or more sections until the seats in a section are contiguous. In some embodiments, the section generator 204 may be configured to reassign seats from one section to another, even if the reassignment violates the seat grouping metric ranges and/or values assigned to each section in order to satisfy the restriction specified by the seat grouping parameters. The section generator 204 may be configured to attempt one or more changes in the grouping of sections to satisfy the restriction specified by the seat grouping parameters. For example, the section generator 204 may, after grouping seats into sections, that a grouping of one seat does not satisfy the seat grouping parameters. The seat grouping parameter may specify a restriction that each seats in a section should be in a same-section block of at least 4 seats. If the restriction is satisfied for all but one seat with the grouping the section generator may be assign the one seat to a nearest section ignoring the seats seat grouping metric.

In some embodiments, the section generator 204 may be configured to cause a notification when the seat grouping does not satisfy the seat grouping parameters. The system 108 may be configured to present an event provider and/or an inventory manager with a user interface. The interface, generated and presented by the interface module 212 may be configured to include a representation of the venue with an indication of the grouping of seats. The representation of the venue may include indications as to which grouping restriction, preferred characteristics, and/or grouping parameters are not satisfied by the grouping. The interface and the representation of the venue generated by the interface module 212 may include options to receive input to define or change the seat grouping parameters, manually change the seat grouping, change ranges of the seat grouping metric that define the sections and the like.

For example, the range generator 202 may determine ranges and/or values for the seat grouping metric that define the grouping of seats into sections. The grouping of seats into sections may not satisfy the seat grouping parameters. A seat grouping parameter may include a restriction specifying that all the seats in a section should be contiguous or physically next to one another, for example. The grouping of the seats into sections may result in non-contiguous sections. Seats grouped into one section may be isolated or separated by seats from other sections. The section generator 204 may attempt to resolve the violation of the seat grouping parameters by changing the ranges of values of the seat grouping metric used for the grouping. The section generator 204 may be configured to change or relax the ranges by 5% or more. The section generator 204 may be configured to increase the number of sections, move orphaned seats into nearest sections, and the like. If the changes do not satisfy the restriction the a user interface may be generated by the user interface module. In some instances (e.g., immediately or after one or more resolution attempts), an error is returned if the restriction cannot be satisfied. The user interface may allow modification of the parameters, sections, ranges of seat grouping metric values, and the like.

Although a specific embodiment of the ticket inventory management system 108 is shown in FIG. 2, embodiments of the present invention are not limited to this example and in other implementations, not all outputs of the system and not all inputs of the system may be available. For example, in some embodiments the seat grouping metric may be an input to the system 108 from an external source while in other embodiments the seat grouping metric may not be an input but may be determined from data by the system. Additional data sources may be available in some systems. The different modules of the system and their respective functions may be combined into one module, divided into more than one block or module and the like. As an example, a metric generator and a range generator may be combined in some embodiments.

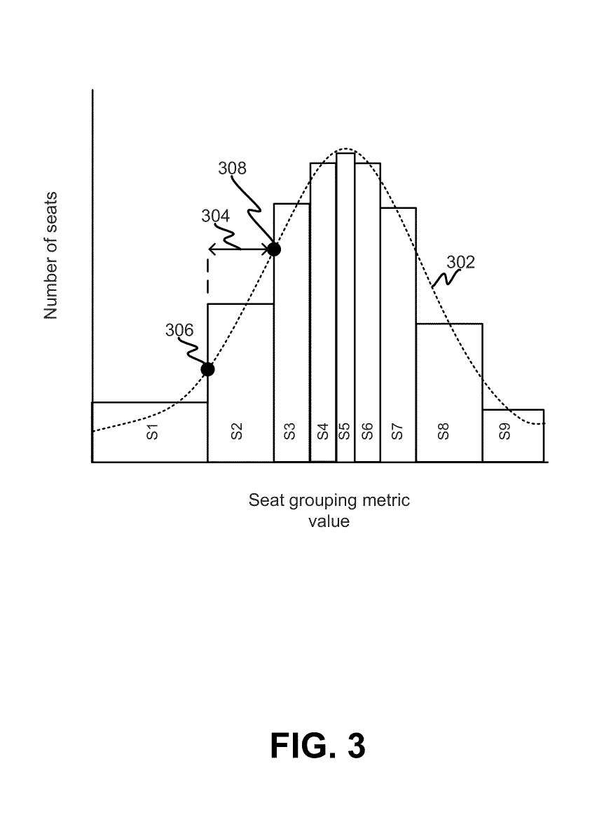

FIG. 3 shows one visual representation of an example method the range generator 202 may use to define the ranges and/or values for sections. The range generator 202 may use one or more rounding, selection, and fitting techniques and algorithms to define the ranges of values and/or the values of the seat grouping metric that specify the grouping of seats into sections. The range generator 202 may select or define values of the metric for grouping seats into sections. A seat grouping metric calculated for the seats in a venue may have non-uniform distribution. Ranges and/or values of the metric may be selected with non-uniform spacing for each section. One example of a seat grouping distribution 302 is shown in FIG. 3. To generate the ranges of values of the seat grouping metric, the range generator 202 may take into account the non-uniform seat grouping metric distribution. The seat grouping metric may be divided into sections by selecting ranges. In the example of FIG. 3, the seat grouping metric is divided into nine sections S1-S9. Each section has a range of values of the seat grouping metric. For example, section two (S2), is defined by an upper bound 308 and a lower bound 306 to define a range 304 of the seat grouping metric. Seats that have a seat grouping metric value that falls in the range 304 may be assigned to section two. The ranges of the seat grouping metric that define each section may different.

As shown in the example in FIG. 3, section 5 (“S5”) is defined by a relatively narrow range of values of the seat grouping metric due to the distribution of the values. This embodiment may provide a rather uniform distribution of tickets per section despite a non-uniform distribution of the metric. It will be appreciated that other distribution conversion (e.g., uniform metric distribution to non-uniform section distribution, skewed metric distribution to non-skewed section distribution, or non-uniform metric distribution to non-uniform section distribution).

The range generator 202, metric generator 210, interface module 212, and other parts of the ticket inventory management system 108 may be used to modify the grouping of seats, ticket price levels, and other properties associated with the seats. Existing (e.g., default) definitions of ranges and/or values of the seat grouping metric may be modified or changed. For example, a default number of groups (e.g., a parameter) can be identified for a particular venue or event type, and an inventory manager can subsequently adjust the parameter or other parameters influencing the group number. Price levels assigned to each section, the size of the sections and the like may be modified by an event provider or an inventory manager. For example, after groups are defined, the event provider or inventory manager can set a price for each group. As another example, before the groups are defined, a maximum and minimum price (or average price) can be defined, and prices can be accordingly set based on the number of groups. The modifications may be performed during the onsale period of for an event. The modifications may be performed before the sale of tickets for an event to modify a predicted revenue potential, sell-out date, demographics, rate of sale, and the like.

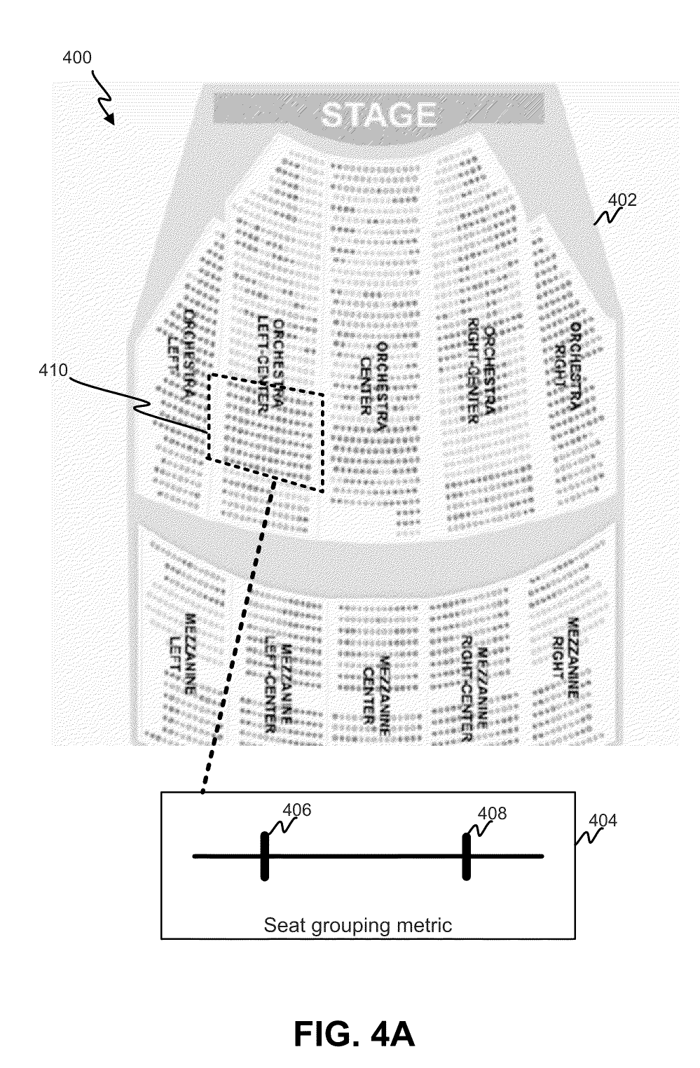

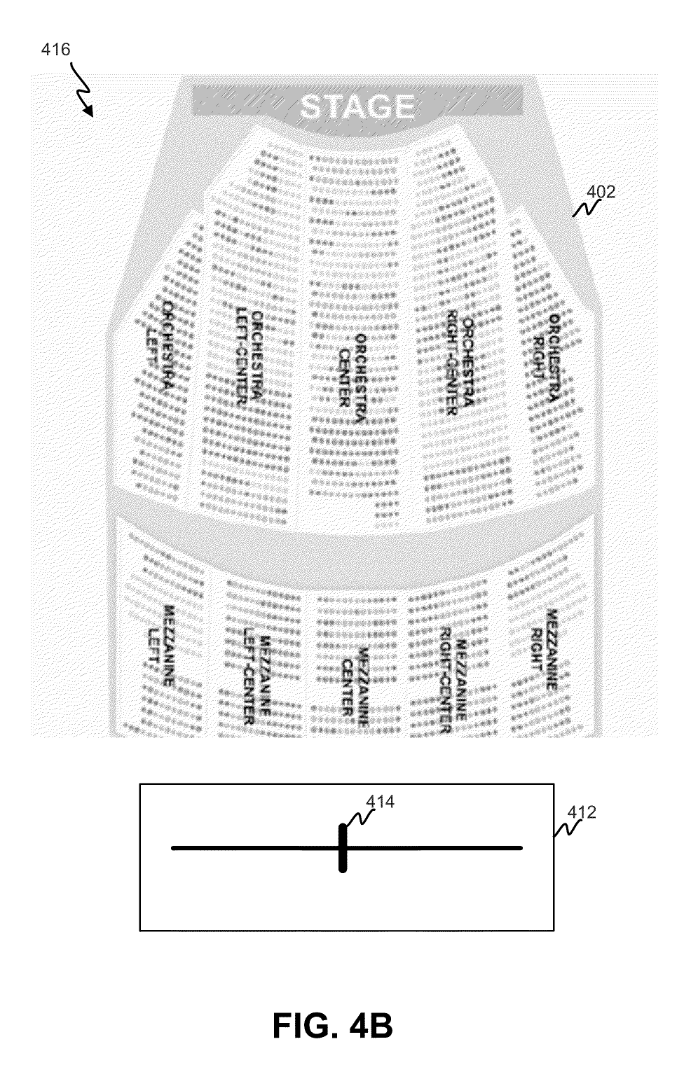

FIG. 4A depicts an embodiment of an example interface 400 an event provider or an inventory manager may use to change or alter the grouping of seats, and/or their other properties. In one embodiment, a venue seat map 402 may be generated. The venue seat map 402 may depict the locations of the seats and an indication of the grouping of the seats. As a result, a number of seats can also be identified. The indication of sections may be indicated by coloring of seats, areas, lines, and the like.

The grouping of a section may be changed with the interface 400. A seat section 410 may be selected. A selection may activate one or more controls 404 for setting one or more parameters, ranges, values, or properties that define the section. The controls may include sliders, text boxes, calendars, and the like. In one example, the control 404 may be used to define or change the date ranges of historical sales data used to compute the metric. In another example, the control 404 may be used to define or change the seat grouping metric ranges and/or value that define the grouping of seats into a section. The control 404 may be a slider, for example, with sliders 406, 408 that may be moved on a scale to define a range of the seat grouping metric values that is used to group seats into the section. For example, the slider's position along a slider could indicate a desired per-section seat number or number of sections. Modifying the ranges may result in a visual representation of the effect of the changes on the venue seat map 402. Price levels, availability, and the like may also be changed using the interface 400.

In some instances, an identified section can include non-contiguous seats. For example, a single section can include a block of seats on one side a stadium and another block of seats on the other side. If the event provider or inventory manager selects a block and adjusts a parameter, the adjustment may affect just the selected seat block (e.g., to adjust its block size) or all blocks within the section.

FIG. 4B depicts an embodiment of an example interface 416 that an event provider or an inventory manager may use to change the grouping of seats in a venue. The interface 416 may include one or more controls 412 for indicating a seat grouping parameter, a data value or data ranges of the seat grouping metric and the like. Altering the indication in the control may cause the seat grouping to be dynamically recalculated and identified on the venue seat map 402.

Thus, FIG. 4A illustrates how a control can be tied to a specific section or block of seats, and FIG. 4B illustrates a global control that can be tied to multiple or all sections. In the case of the slider control, for example, a slider indicator 414 may be moved causing the seat grouping to be recalculated and determined for the whole venue. The interface 416 may further include indications of potential or expected revenues, sale dates, sale rates, and/or ranges or distributions thereof predicted based on the seat groupings. A number of predictive techniques may be used taking into account one or more data sources as, for example, those described in U.S. application Ser. No. 11/702,803 filed on Feb. 6, 2007, which is hereby incorporated by reference in its entirety for all purposes.

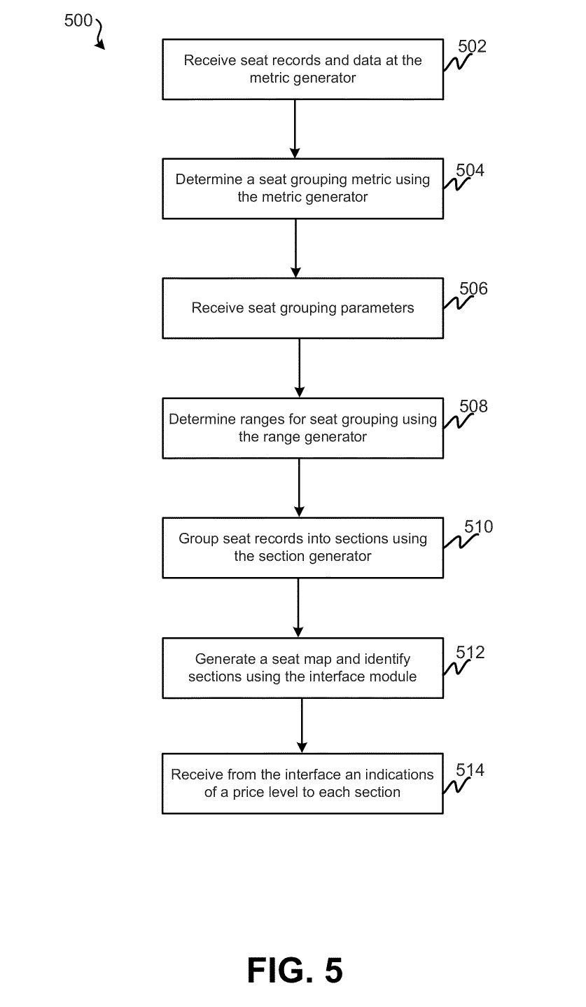

FIG. 5 illustrates a flowchart of an embodiment of a process 500 for grouping seats into sections. Process 500 begins at block 502, where the metric generator 210 receives seat records. The seat records may be a data structure or a database record for a seat in a venue. Each seat record may be associated with a separate seat in the venue and ticket for the seat. A seat record may include additional information about the seat, ticket, venue, or event of the ticket. The seat record may include the location of the seat in the venue and a ticket price of the ticket associated with the seat. Each seat record may include meta-data definitions describing the information of each seat record, how the information was derived, its source, and the like. Using, at least in part, the data from each seat record, the metric generator 210 determines a seat grouping metric for each seat at block 504. The seat grouping metric may include a numerical value, a date, more than one value or date, or other metric. The seat grouping metric may be used to group seats into sections. At block 506 one or more seat grouping parameters may be received. The seat grouping parameter(s) may include a restriction on of a section or how the seats are grouped into sections. The seat grouping parameter may specify hard and soft requirements indicating preferred grouping or section properties and optional properties.

In block 508, the range generator 202 determines a range of values and/or specific values of the seat grouping metric to define a seat section. In some instances, a range or value is determined for each section. The range and/or values may be computed based on a seat grouping parameter. The section generator 204 groups seats into sections based at least in part on the ranges of values and/or values at block 510. An indication of the grouping may be added to each seat record. Additional data may be added or data of the seat record may be updated to indicate what section the seat associated with the seat record is assigned to.

In block 512, the interface module 212 generates a seat map, which can be displayed by module 212 to an inventory manager. The seat map may identify the sections of seats. The sections may be identified with different colors of the seats, highlighting a border around the seats, and the like. The seat map may identify whether the restriction on grouping specified by the seat grouping parameters were satisfied. In block 514, one or more seat sections may be assigned a price. This assignment can result in assigning a price to one, more or each seat record within the section. Each seat grouped into a section may be assigned the same price for each ticket. In some embodiments, each seat grouped into a particular section may be assigned a similar or same price. The prices of tickets in a section may be identical to, similar to or within a specific range of one another. For example, the difference between the highest priced and the lower prices ticket for seats in a section may be limited to no more than 50% of the price of the lowest price ticket in the section. Differences in ticket prices for seats grouped into one section may correspond to the values of the seat grouping metric calculated for each seat in the section.

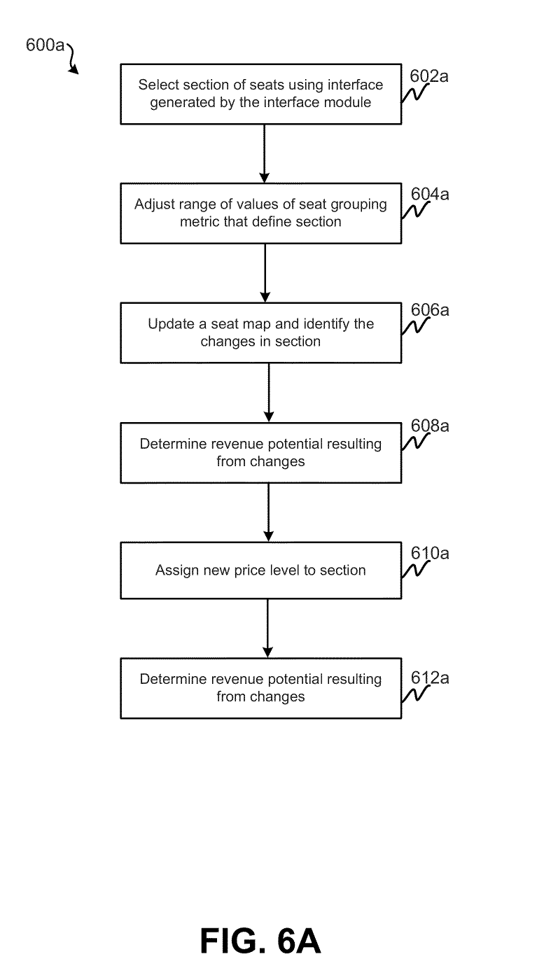

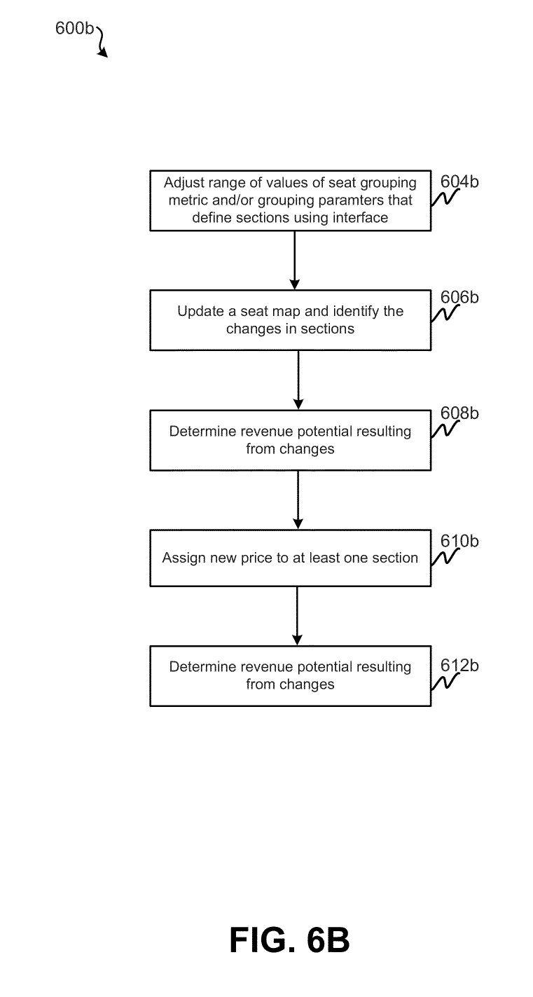

After seats have been grouped and assigned a price level, the grouping of the seats may be modified in response to input from an inventory manager, new data, sale progress, time to event, revenue expectations, and the like. FIG. 6A illustrates a flowchart of an embodiment of a process 600a for changing grouping of seats into sections. At block 602a, interface module 212 may receive a selections of one or more section from an inventory. The selection may be made with a command line interface or another selection tool, which can include one or more various controls for selecting and or modifying a selection. The selection tool may include slider, text boxes, mouse scroll capture control, and the like. Using the interface, the ranges of values of the seat grouping metric that define a section may be adjusted or set in block 604a using the interface module 212. The number of sections and the size of the seats in each section may be increased or decreased as may be the price level of each section. In some embodiments, metric generator 210 may suggest potential changes to the sections, grouping, or pricing levels of the section. The suggestion may be generated based on sales data (e.g., ticket prices, sales speed, and/or inventory sold). The suggestion may be generated based on historical sales data and effects of changes in past events and venues. Changes in the grouping of seats into sections may be reflected in an updated seat map representation in block 606a by the interface module 212. A potential revenue (or profit) change due to the changes may be calculated in block 608a by the output processing module 206. The potential revenue change may reflect the predicted change in sales due to the changes. The predicted change in sales may be based on estimates or predictions from historical data or other events. In block 610a the inventory manager may further identify a new price using the interface 212. A potential revenue change due to the changes in price level may be calculated in block 612a.

FIG. 6B illustrates a flowchart of an embodiment of a process 600b for changing grouping of seats into sections. Blocks 604b-612b in process 600b can be similar to blocks 604a-612a in process 600a. However, in process 600b, block 602a from process 600a is omitted. Further, at block 604b, the adjusting of the metric or parameters results in the updating of potentially more than one section in response to the change. A change in the metric and/or parameters may cause a recalculation of the ranges, groupings, metrics and the like for the whole venue. One or more controls, such as sliders, buttons, text boxes, and the like may be used to receive an indication of the changes vi the interface. The updated section and revenue potential may be displayed using the interface 212 in block 606b. Similarly to bock 608a, revenue potentials from the changes may be determined in block 608b. The price of assigned to one or more sections may be changed in block 610b the revenue potential recalculated based on the changes in 612b.

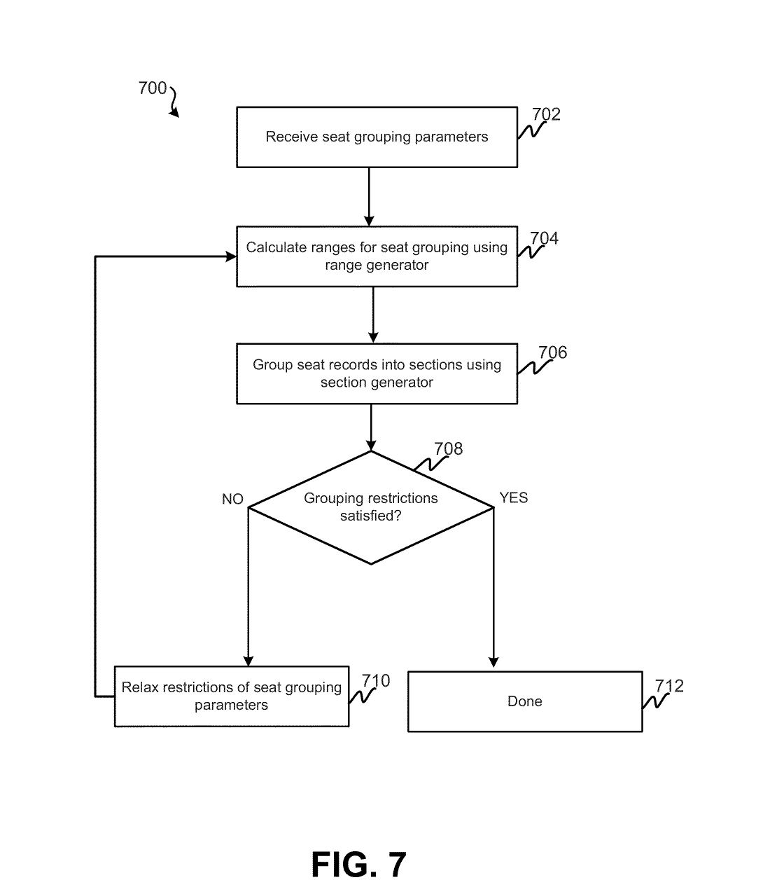

FIG. 7 illustrates a flowchart of an embodiment of a process 700 for determining ranges of metrics for grouping that meet grouping restriction. For some events or venues, it may be difficult, if at all possible, to group seats into sections using the seat grouping metric while satisfying grouping restriction defined by the seat grouping parameters. Attempts can be made to nonetheless satisfy some grouping restriction or to work in a direction of the restriction. For example, restriction can be gradually relaxed until they can be satisfied. As shown in FIG. 7, the process 700 may begin with block 702 where one or more seat grouping parameters that specify one or more restrictions on the seat groupings may be received by the system 108. A restriction may include, for example, number of sections, maximum seats in a section, spatial constraints, and or the like. Restriction may be rated according to importance. Some of the parameters or requirements specified by the parameters may be required while other may be optional. The range generator 202 may, in block 704, calculate or determine a range of values and/or specific values of the seat grouping metric that may be used to groups seats into sections. Based on the ranges the seats may be grouped into sections by the section generator 204 in block 706. In block 708 the grouping of the seats into section from block 706 may be verified or checked by the section generator 204 to ensure all of the grouping restriction are satisfied. If all the restriction are satisfied the process may terminate in block 712. If the restriction are not satisfied some of the seat grouping parameters or restriction may be relaxed in block 710. The process may then return to recalculate the seat grouping using the range generator 202 in 704 based on the relaxed restriction and seat grouping parameters. In some embodiments, the process may relax the parameters and the grouping restriction based on their ranking. Parameters or restriction identified as optional may be ignored or relaxed in the first iterations of the process 700. If a grouping does not satisfy the parameters and restriction after all of the optional parameters are ignored and relaxed the required parameters may be relaxed or ignored until a solution is found.

In some embodiments, the process of FIG. 7 may be reversed. In alternative embodiments, the computation of block 704 may attempt to first group using only all of the required and/or top ranked grouping parameters. If the grouping of seats into section may be generated that satisfies the parameters, optional grouping parameters may be added. The grouping may be recalculated until the restriction and grouping parameters are satisfied or a grouping solution cannot be found.

In some embodiments, the systems and methods described herein may be adapted to group seats into sections for a staged ticket release schedule. When tickets are released for an event, the tickets may be released in batches or groups. A release schedule may dictate how many and which seats are released for sale, the price of the tickets, the distributions channels used for the release, and the like. Tickets that have not yet been released are “held”.

For example, in one embodiment of a release schedule, one section or group of premium seats may be released two months before an event, while additional less expensive group of seats may be initially held and not be released until one month before an event. The release schedule of tickets may impact the revenue, the number of tickets sold, the price of the tickets, and the like.

The release schedule and/or the grouping of tickets may be different for different venues, performers, times of the year, and the like. Based on the demographic of customers, for example, a specific release schedule may generate more revenue than other release schedules. For some events, releasing premium tickets, or tickets for seats in front rows, followed by tickets for less expensive seats at a later date may generate the most revenue or sell the most tickets. For other events, the revenue for an event may be improved by periodically releasing groups of tickets for a mix of premium and budget seats.

The systems and methods described herein may be used to determine an effective grouping and ticket release strategy. Seats in a venue may be grouped into sections for a staged release schedule. The system may evaluate historical sales trends, demographics, event date, related events, and the like to determine an effective grouping of seats for a release schedule. The seats may be grouped in order to maximize or meet a specific revenue goal, number of tickets sold, sellout date, and the like.

The grouping of seats for a release schedule may be determined prior to an event. The grouping and the release schedule may be determined and assigned prior to any tickets being released and the ticket release schedule followed regardless of outcome. In some embodiments, the grouping of seats and he release schedule for the groups of seats may be dynamically adapted based on the sales of tickets for each release group. The grouping of seats and the release schedule for the groups may be periodically or continuously adjusted based on feedback from the sales of previously released groups of seats. Based on the sale performance of previous released groups the pending unreleased seats may be regrouped, have a delayed release, re-priced, the groups may be made larger/smaller, and the like.

When determining a seat grouping and a release schedule for the groups, the system may evaluate the appropriate time to release a seat or a group of seats to increase or maximize the value or price of the seat or group of seats. The value of a seat and so the price that can be charged for a seat may depend on the time the seat is released in the release schedule as well as what other seats are released concurrently. The grouping of seats may take into consideration the relative impact of a value of a seat in a group. For example, for some demographics of the ticket buyers, a grouping of seats for which there is a small relative difference between the most expensive and least expensive seats may maximize the value of each seat. A large price spread in a release group may make some ticket buyers skeptical of the value of the seats and make some buyers post-pone their purchase, for example. For some other events and demographics, a large price difference in a release group of tickets may motivate the purchase of lower prices tickets as they may seem relatively inexpensive compared to other tickets. In some instances tickets may be grouped to have variety of lower priced tickets and premium tickets so that the price difference between the lower and highest priced tickets is at least two times the price of the lowest price ticket. In determining the grouping and release schedule the system may use demographic information, historical data, and other input data to determine a grouping and release schedule to maximize the value of each seat.

For example, referring now to the system shown in FIG. 1, using the ticket management system 100, an event provider 112 can identify an event (e.g., its name and/or performer(s)), event type, a date or dates of the event, a location or locations of the event, etc. The ticket management system 100 can use the information provided by event provider 112 and/or inventory manager 114 to group tickets into sections, identify a release schedule for the groups of tickets, and/or identify a price level for each ticket in the group. The grouping of seats for a release schedule may be at least partially based on data related to, historical sales data, event demographics, time of sale, secondary market ticket prices, and/or physical characteristics of the location of the seats. An inventory manager 114 and/or event provider 112 can then use the ticket inventory management system 108 to modify the price levels of the tickets in each group and/or change the release schedule of the groups. Ticket inventory management system 108 may present to the inventory manger 114 and/or event provider 112 a set of tools and/or a graphical user interface for managing the release schedule. The tools and user interface may present the inventory manger 114 and/or event provider 112 with a venue map with an indication of groups and release schedule determined based on the metrics, with an indication of computed metrics (e.g., presented over the venue map). A section generator 204 from FIG. 2 may be used to generate grouping of seats for the release schedule.

Similarly, the grouping and the release schedule may be modified and adjusted by an interface depicted in FIG. 4B, allowing an event provider or an inventory manager to change the grouping and/or the release schedule of the grouped seats. The interface 416 may include one or more controls 412 for indicating a seat grouping and/or release schedule parameters. Altering the indication in the control may cause the seat grouping and the release schedule to be dynamically recalculated and identified on the venue seat map 402.

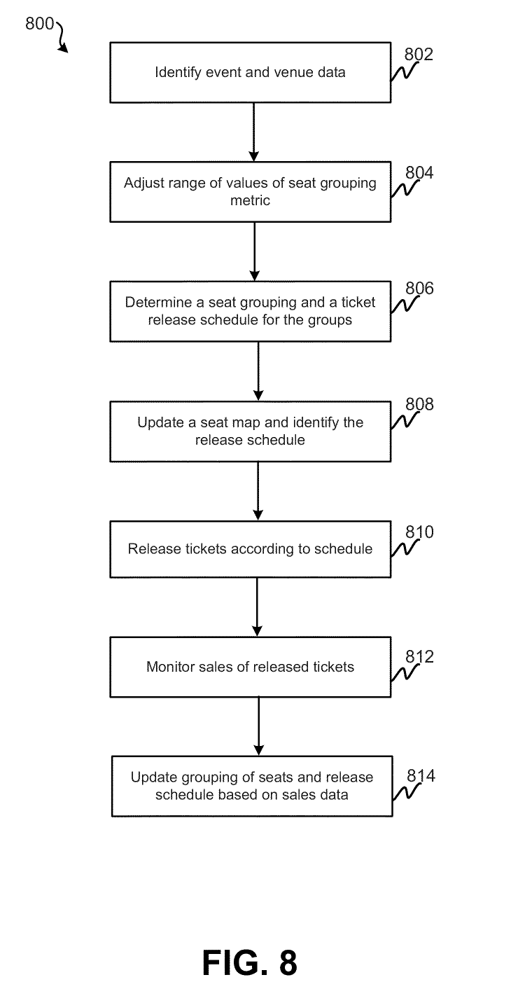

FIG. 8 illustrates a flowchart of an embodiment of a process 800 for grouping of seats and generating a release schedule for the groups of seats. At block 802, interface module 212 may receive a selections of one or more events and venues. In block 804 the interface module may receive input as to the range of values for of a seat grouping metric used for generating groups of seats for the release schedule. The input may include release schedule characteristics or properties, such as number of release dates, number of seats in each release batch or group. The input may include a ranking of targets for the release schedule related to revenue, sell-out date, rate of sale, and/or the like. The input may be made with a command line interface or another selection tool, which can include one or more various controls. The input tool may include slider, text boxes, mouse scroll capture control, and the like. Based on the input characteristics and additional data related to the venue, event, historical data, and the like, the grouping of seats for the release schedule may be determined in block 806. In block 808 the seat map of the interface may updated to show the grouping of seats and the release schedule. The seat map may include controls to show and/or to step through the sequence of release events and can display which groups of seats are planned to be released at which time and/or into what distribution channels. In embodiments, the seat map include controls for showing the modeled or predicted sales for the grouping of the and the release schedule. The interface and the seat map may be used to modify the grouping and the release schedule by the inventory manager. The number of seats in each release group may be increased or decreased as may be the price level of each seat.

In block 810 the release schedule may be approved by the inventory manager and activated for release. During the release schedule the sales of the tickets may be monitored in block 812. Based on the sales, the metric generator 210 may suggest potential changes to the grouping and/or the release schedule. The suggestion may be generated based on sales data (e.g., ticket prices, sales speed, and/or inventory sold). The suggestion may be generated based on historical sales data and effects of changes in past events and venues. Changes in the grouping of seats and the release schedule may be reflected in an updated seat map representation.

In embodiments, the methods described herein may also be used to group seats into sections taking into account more than one event (e.g., a group of events at a venue). Data related to multiple events may be collected and factored into generating sections and price levels for the sections allowing user to evaluate the cost and purchase season tickets or a group or collection of tickets at a time. The system may be used and extended to group or bundle multiple events into a package. Multiple concerts, sporting events, or other events may be evaluated, and an event metric may be assigned to the events for grouping based on the metric. Characteristics of events may be determined based on previous sales, attendance demographics, event activities, and the like to generate event metric. Events with similar metric scores may be grouped and tickets for the grouped events may be bundled and sold together as a package. Tickets for specific games of a sports team, for example, may be bundled and sold as a package based on grouping according to the metric score. The tickets may be for specific seats in a venue for the bundled events. In some embodiments, the tickets may be for different seats in the venue.

It is to be understood although the system has been described with respect to grouping and pricing of seats in a venue the methods may be used on any resource related to tickets in a venue. In some venues, seat resources and/or seat records may not comprise physical seats but general locations in a venue. Venues may be, for example, standing room only wherein sections are designated by an area where a person with a designated ticket is allowed to be.

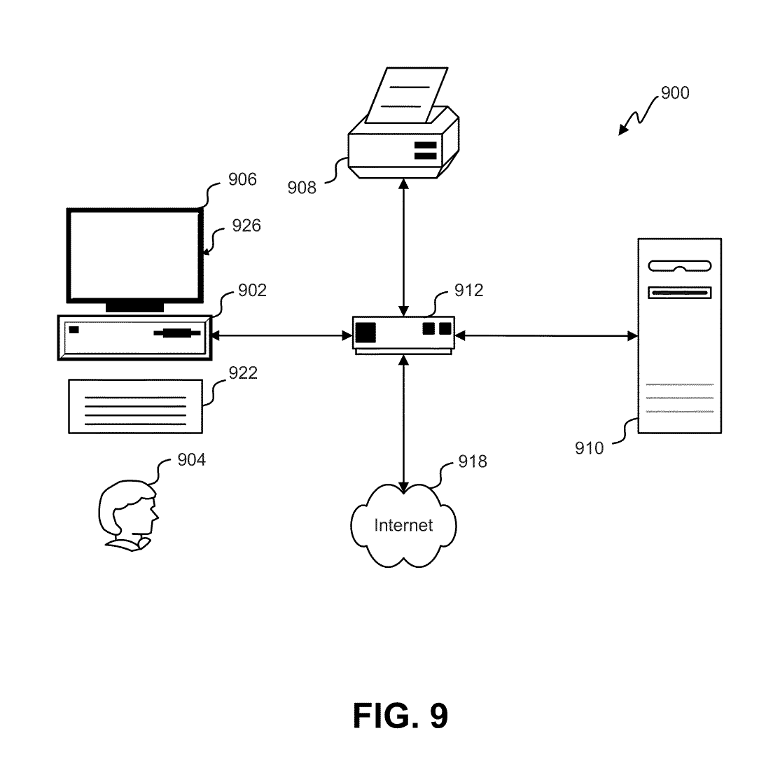

Referring next to FIG. 9, an exemplary environment with which embodiments can be implemented is shown with a computer system 900 that can be used by an inventory manager 904 to manage, for example, the venue ticket inventory. The computer system 900 can include a computer 902, keyboard 922, a network router 912, a printer 908, and a monitor 906. The monitor 906, processor 902 and keyboard 922 are part of a computer system 926, which can be a laptop computer, desktop computer, handheld computer, mainframe computer, etc. Monitor 906 can be a CRT, flat screen, etc.

An inventory manager 904 can input commands into computer 902 using various input devices, such as a mouse, keyboard 922, track ball, touch screen, etc. If the computer system 900 comprises a mainframe, an inventory manager 904 can access computer 902 using, for example, a terminal or terminal interface. Additionally, computer system 926 can be connected to a printer 908 and a server 910 using a network router 912, which can connect to the Internet 918 or a WAN.

Server 910 can, for example, be used to store additional software programs and data. In one embodiment, software implementing the systems and methods described herein can be stored on a storage medium in server 910. Thus, the software can be run from the storage medium in server 910. In another embodiment, software implementing the systems and methods described herein can be stored on a storage medium in computer 902. Thus, the software can be run from the storage medium in computer system 926. Therefore, in this embodiment, the software can be used whether or not computer 902 is connected to network router 912. Printer 908 can be connected directly to computer 902, in which case, computer system 926 can print whether or not it is connected to network router 912.

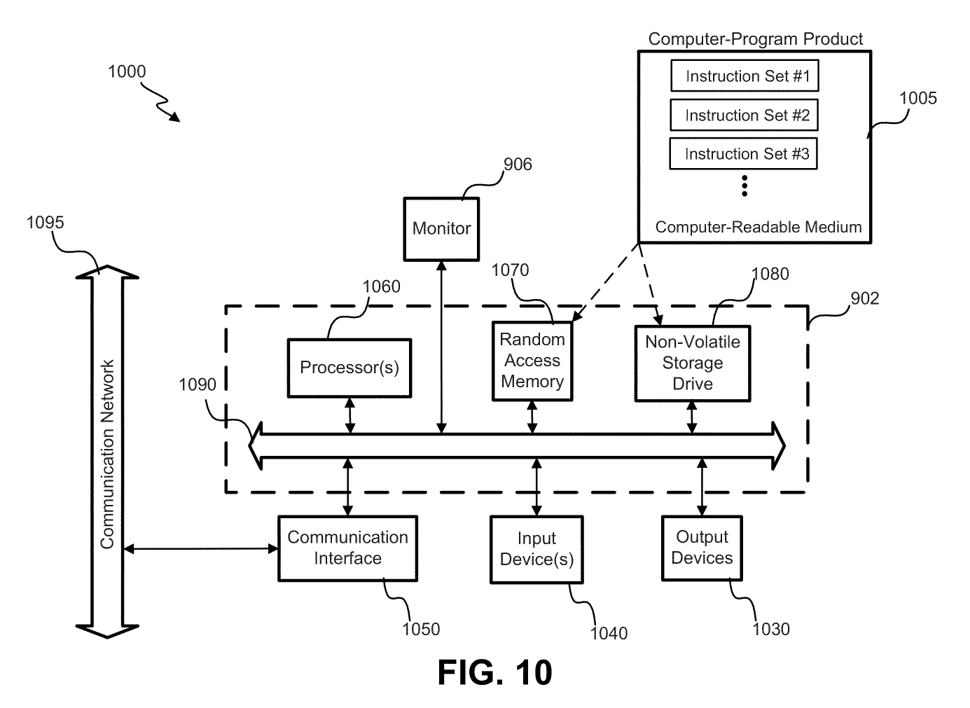

With reference to FIG. 10, an embodiment of a special-purpose computer system 1000 is shown. Ticket inventory management system 108 and/or any components thereof are examples of a special-purpose computer system 1000. Thus, for example, one or more special-purpose computer systems 1000 can be used to provide the function of ticket inventory management system 108. The above methods can be implemented by computer-program products that direct a computer system to perform the actions of the above-described methods and components. Each such computer-program product can comprise sets of instructions (codes) embodied on a computer-readable medium that directs the processor of a computer system to perform corresponding actions. The instructions can be configured to run in sequential order, or in parallel (such as under different processing threads), or in a combination thereof. After loading the computer-program products on a general purpose computer system 926, it is transformed into the special-purpose computer system 1000.

Special-purpose computer system 1000 comprises a computer 902, a monitor 906 coupled to computer 902, one or more additional user output devices 1030 (optional) coupled to computer 902, one or more user input devices 1040 (e.g., keyboard, mouse, track ball, touch screen) coupled to computer 902, an optional communications interface 1050 coupled to computer 902, a computer-program product 1005 stored in a tangible computer-readable memory in computer 902. Computer-program product 1005 directs system 1000 to perform the above-described methods. Computer 902 can include one or more processors 1060 that communicate with a number of peripheral devices via a bus subsystem 1090. These peripheral devices can include user output device(s) 1030, user input device(s) 1040, communications interface 1050, and a storage subsystem, such as random access memory (RAM) 1070 and non-volatile storage drive 1080 (e.g., disk drive, optical drive, solid state drive), which are forms of tangible computer-readable memory.

Computer-program product 1005 can be stored in non-volatile storage drive 1090 or another computer-readable medium accessible to computer 902 and loaded into memory 1070. Each processor 1060 can comprise a microprocessor, such as a microprocessor from Intel® or Advanced Micro Devices, Inc®, or the like. To support computer-program product 1005, the computer 902 runs an operating system that handles the communications of product 1005 with the above-noted components, as well as the communications between the above-noted components in support of the computer-program product 1005. Exemplary operating systems include Windows® or the like from Microsoft Corporation, Solaris® from Sun Microsystems, LINUX, UNIX, and the like.

User input devices 1040 include all possible types of devices and mechanisms to input information to computer system 902. These can include a keyboard, a keypad, a mouse, a scanner, a digital drawing pad, a touch screen incorporated into the display, audio input devices such as voice recognition systems, microphones, and other types of input devices. In various embodiments, user input devices 1040 are typically embodied as a computer mouse, a trackball, a track pad, a joystick, wireless remote, a drawing tablet, a voice command system. User input devices 1040 typically allow a user to select objects, icons, text and the like that appear on the monitor 906 via a command such as a click of a button or the like. User output devices 1030 include all possible types of devices and mechanisms to output information from computer 902. These can include a display (e.g., monitor 906), printers, non-visual displays such as audio output devices, etc.

Communications interface 1050 provides an interface to other communication networks and devices and can serve as an interface to receive data from and transmit data to other systems, WANs and/or the Internet 918. Embodiments of communications interface 1050 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1050 can be coupled to a computer network, to a FireWire® bus, or the like. In other embodiments, communications interface 1050 can be physically integrated on the motherboard of computer 902, and/or can be a software program, or the like.

RAM 1070 and non-volatile storage drive 1080 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1070 and non-volatile storage drive 1080 can be configured to store the basic programming and data constructs that provide the functionality of various embodiments of the present invention, as described above.

Software instruction sets that provide the functionality of the present invention can be stored in RAM 1070 and non-volatile storage drive 1080. These instruction sets or code can be executed by processor(s) 1060. RAM 1070 and non-volatile storage drive 1080 can also provide a repository to store data and data structures used in accordance with the present invention. RAM 1070 and non-volatile storage drive 1080 can include a number of memories including a main random access memory (RAM) to store of instructions and data during program execution and a read-only memory (ROM) in which fixed instructions are stored. RAM 1070 and non-volatile storage drive 1080 can include a file storage subsystem providing persistent (non-volatile) storage of program and/or data files. RAM 1070 and non-volatile storage drive 1080 can also include removable storage systems, such as removable flash memory.

Bus subsystem 1090 provides a mechanism to allow the various components and subsystems of computer 902 communicate with each other as intended. Although bus subsystem 1090 is shown schematically as a single bus, alternative embodiments of the bus subsystem can utilize multiple busses or communication paths within computer 902.

Specific details are given in the above description to provide a thorough understanding of the embodiments. However, it is understood that the embodiments can be practiced without these specific details. For example, circuits can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps and means described above can be done in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. A computer-implemented method of grouping seats in a venue, the method comprising:
accessing a set of seat records, wherein each seat record of the set of seat records corresponds to a seat in the venue, and wherein each seat record of the set of seat records comprises data associated with the seat in the venue, the data including an identification of a location within the venue;
determining, for each seat record in the set of seat records, a seat grouping metric based on the data of the seat record;
receiving a first group size parameter provided by an inventory manager via a graphical user interface;
identifying, using the first group size parameter, a first subset of the set of seat records based on a plurality of the determined seat grouping metrics;
for each seat record in the first subset, assigning the seat to a first group in a first plurality of groups, at least one group in the first plurality of groups including at least one seat in a first section and at least one other seat in a second section, each of the first section and the second section corresponding to a defined physical location within the venue;
for each seat record in the first subset, assigning a first price for the seat based on the assigned first group;
estimating a first revenue based on the assigned first prices;
identifying a second group size parameter;
identifying, using the second group size parameter, a second subset of the set of seat records;
for each seat record in the second subset, assigning the seat to a second group a second plurality of groups;
for each seat record in the second subset, assigning a second price for the seat based on the assigned second group;
estimating a second revenue based on the assigned second prices; and
presenting to the inventory manager via the graphical user interface:
a seat map for the venue that indicates that seats corresponding to seat records in the first subset are assigned to the first assigned group;
the first estimated revenue;
the second estimated revenue; and
a control for facilitating selection of a group size parameter.

2. The method of claim 1, further comprising:
receiving input via the control that the second parameter has been selected by the control; and
dynamically modifying the presented seat map such that it indicates that seats corresponding to seat records in the second subset are assigned to the second assigned group.

3. The method of claim 1, wherein the price assigned to each seat record in the subset is the same.

4. The method of claim 1, wherein the data further includes historical sale statistics for the seat.

5. The method of claim 1, wherein the seat map, the first estimated revenue, the second estimated revenue and the control are presented concurrently in the graphical user interface.

6. The method of claim 1, wherein estimating the first revenue includes predicting revenue, profit or sales for an event.

7. (canceled)

8. A ticket inventory management system, the system comprising:
one or more processors; and
one or more memories coupled with the one or more processors, wherein the one or more processors and one or more memories are configured to:
access a set of seat records, wherein each seat record of the set of seat records corresponds to a seat in the venue, and wherein each seat record of the set of seat records comprises data associated with the seat in the venue, the data including an identification of a location within the venue;
determine, for each seat record in the set of seat records, a seat grouping metric based on the data of the seat record;
receive a first group size parameter provided by an inventory manager via a graphical user interface;
identify, using the first group size parameter, a first subset of the set of seat records based on a plurality of the determined seat grouping metrics;
for each seat record in the first subset, assign the seat to a first group in a first plurality of groups, at least one group in the first plurality of groups including at least one seat in a first section and at least one other seat in a second section, each of the first section and the second section corresponding to a defined physical location within the venue;
for each seat record in the first subset, assign a first price for the seat based on the assigned first group;
estimate a first revenue based on the assigned first prices;
identify a second group size parameter;
identify, using the second group size parameter, a second subset of the set of seat records;
for each seat record in the second subset, assign the seat to a second group a second plurality of groups;
for each seat record in the second subset, assign a second price for the seat based on the assigned second group;
estimate a second revenue based on the assigned second prices; and
present to the inventory manager via the graphical user interface:
a seat map for the venue that indicates that seats corresponding to seat records in the first subset are assigned to the first assigned group;
the first estimated revenue;
the second estimated revenue; and
a control for facilitating selection of a group size parameter.

9. The ticket inventory management system of claim 8, wherein the one or more processors and one or more memories are further configured to:
receive input via the control that the second parameter has been selected by the control; and
dynamically modify the presented seat map such that it indicates that seats corresponding to seat records in the second subset are assigned to the second assigned group section.

10. The ticket inventory management system of claim 8, wherein the price assigned to each seat record in the subset is the same.

11. The ticket inventory management system of claim 8, wherein the data further includes historical sale statistics for the seat.

12. The ticket inventory management system of claim 8, wherein the seat map, the first estimated revenue, the second estimated revenue and the control are presented concurrently in the graphical user interface.

13. The ticket inventory management system of claim 8, wherein estimating the first revenue includes predicting revenue, profit or sales for an event.

14. (canceled)

15. A ticket inventory management system, the ticket inventory management system comprising:
a metric generator that:
accesses a set of seat records, wherein each seat record in the set of seat records corresponds to a seat in the venue, and wherein each seat record in the set of seat records comprises data associated with the seat in the venue, the data including an identification of a location within the venue, and
determines, for each seat record in the set of seat records, a seat grouping metric based on the data of the seat record;
a group generator that:
receives a first group size parameter provided by an inventory manager via a graphical user interface;
identifies, using the first group size parameter, a first subset of the set of seat records based on a plurality of the determined seat grouping metrics, and
for each seat record in the first subset, assigns the seat to a group in a first plurality of groups, at least one group in the first plurality of groups including at least one seat in a first section and at least one other seat in a second section, each of the first section and the second section corresponding to a defined physical location within the venue;
identifies a second group size parameter;
identifies, using the second group size parameter, a second subset of the set of seat records, and
for each seat record in the second subset, assigns the seat to a group in a second plurality of groups;
a processing module that:
for each seat record in the first subset, assigns a first price for the seat based on the assigned first group;
for each seat record in the second subset, assigns a second price for the seat based on the assigned second group;
estimates a first revenue based on the assigned first prices;
estimates a second revenue based on the assigned second prices; and
an interface module that presents to the inventory manager via the graphical user interface:
a seat map for the venue that indicates that seats corresponding to seat records in the first subset are assigned to the first assigned group;
the first estimated revenue;
the second estimated revenue; and
a control for facilitating selection of a group size parameter.

16. The ticket inventory management system of claim 15, wherein:
the interface module further receives input via the control that the second parameter has been selected by the control; and
the interface module further dynamically modifies the presented seat map such that it indicates that seats corresponding to seat records in the second subset are assigned to the second assigned group.

17. The ticket inventory management system of claim 15, wherein the price assigned to each seat record in the subset is the same.

18. The ticket inventory management system of claim 15, wherein the data further includes historical sale statistics for the seat.

19. The ticket inventory management system of claim 15, wherein the seat map, the first estimated revenue, the second estimated revenue and the control are presented concurrently in the graphical user interface.

20. (canceled)

21. The method of claim 1, wherein the control for facilitating selection of the group size parameter includes a slider to enable the inventory manager to set the group size parameter to a value within a range of values.

22. The ticket inventory management system of claim 8, wherein the control for facilitating selection of the group size parameter includes a slider to enable the inventory manager to set the group size parameter to a value within a range of values.

23. The ticket inventory management system of claim 15, wherein the control for facilitating selection of the group size parameter includes a slider to enable the inventory manager to set the group size parameter to a value within a range of values.

24. The method of claim 1, further comprising:
receiving input via the control that the first parameter has been selected by the control.

25. The method of claim 1, further comprising:
determining, based on the first group size parameter, a range of values of the seat grouping metric, and wherein identifying the first subset of the set of seat records is further based on the determined range of values of the seat grouping metrics.

26. The ticket inventory management system of claim 15, further comprising:
a range generator that:
receives a seat grouping parameter provided by an inventory manager via a graphical user interface, and
determines, based on the first group size parameter, a range of values for the seat grouping metric; and
wherein the group generator identifies the first subset of the set of seat records based further on the determined range of values.
